(19) United States
(12) Patent Application Publication
(10) Pub. No.: US 2003/0175067 A1
(43) Pub. Date: Sep. 18, 2003

(54) Web process for making a binder case

(76) Inventors: Jerry W. Pearce, Stanley, NC (US); Robert S. Schusessler, Vero Beach, FL (US)

Correspondence Address: DOUGHERTY, CLEMENTS & HOFER, 1901 ROXBOROUGH ROAD, SUITE300, CHARLOTTE, NC, 28211, US

(21) Appl. No.: 10/098,995

(22) Filed: Mar. 15, 2002

(51) Int. Cl. B42F 13/00

(52) U.S. Cl. 402/73

(57) ABSTRACT

The invention relates to a specific web roll, a process for making the web roll, and a process for making a casemade binder. The web roll can be: 1) a laminate of plastic film and printed sheets, or 2) a laminate of two plastic films, or 3) a single plastic film. The web roll has images printed on the printed sheets in the first embodiment, images printed on one or both films of the second type, and a reverse printed image on the third embodiment. In each embodiment, the image includes at least one alignment spot that corresponds to each casemade binder. In each application, the web roll is aligned, cut and secured to a substrate for each binder so that the exterior of the binder has the image thereon.

### FIELD OF THE INVENTION

The present invention relates to a process for making a binder case using a web. A web, in this context is a continuous material that is delivered to the process on a roll where it is manipulated using driven and undriven rollers. In particular, the web contains the external appearance image desired in the binder case.

### PRIOR ART

A process for making a binder case includes unrolling the web, properly aligning it according to an indexing means, notching the web on either side of the web at a notch periodicity equal to the appropriate binder case dimension, centering and adhering a substrate board to the appropriate side of the web, the board being smaller than the web width, cutting the web, folding the edges of the web over the board substrate, and centering and securing the liner to the substrate board thereby making a binder case. The ability to fold the binder is effected by either dadoing a pair of grooves in the substrate on either side of the spine or crimping the substrate in a brake. The binder is completed by riveting a ring assembly to the spine of said binder case.

### BACKGROUND OF THE INVENTION

Making binder cases using substrate boards (relatively rigid material such as cardboard, fiberboard, corrugated paper, or chipboard) with many different cover materials such as paper, cloth, polyvinyl chloride plastic, polypropylene etc. is well known. Likewise, employing various liner materials from the same or different materials used in the cover is known. Binder cases typically employ a substrate board with inexpensive plastic sheeting such as polyvinylchloride (PVC), or polyethylene, or polypropylene that covers both sides of the substrate board, and are heat-sealed along the edges by radio frequency welding, for example. These binders are the inexpensive binders well known to those skilled in the art.

Case made binders exceed the quality of the heat sealed edge binders in the following ways: they are better made (the edges of heat sealed binders are sharp and can cut fingers), they are more durable (the heat sealed edges often split), and they have elegant aesthetics (the edges of case made binders are folded over the inside edge of the substrate and a liner is glued over the folded edges, giving the binders the appearance of books). Case made binders frequently have additional options that make them more adaptable for broader uses, such as interior and exterior pockets.

U.S. Pat. No. 6,039,494 to Pearce describes a case made binder with one exterior pocket for placing inserts such as textual information for the front, side edge and back of the binder. This patent does not describe a web, like that of the present invention, for making the exterior of the binder.

Machines such as those made by Crathem Engineering in Contoccook, N.H. are well known and produce case made binders. These machines are capable of producing a range of binder sizes from, for example, 6-inches to 36-inches in height and/or length. These machines can employ roll goods to make case made binders. The roll goods may include decorative designs that are employed for the exterior cover. When a decorative design is used, it is not important to align the design with the front, side and back edges of the binder.

When printed materials in the form of either text or patterns are desired, these are produced using individual sheets of printed material. Alignment on the front, side or back of the binder is important. These printed sheets are individually glued to the substrate board. Alternatively, roll goods are prepared by transfer printing using a cylinder or drum, which continuously prints on a roll of paper with the same repeating pattern. Said drum must have the same circumference as the binder height, or the excess paper must be trimmed away. Therefore a printer must have a myriad of printing drums to cover all sizes of desired binders or waste a lot of paper. This is impractical. A printed roll of material is not practical unless the production desired is sufficiently large to economically support the printing of such roll goods. Large production runs require, therefore, that the machine would be dedicated to a specific size binder.

In order to protect the printed material on the paper either as sheets or in rolls, a clear film of plastic is typically secured to the paper. Polypropylene is clear, inexpensive and was initially employed for this application. However, polypropylene film was found to be totally unsatisfactory with respect to the present invention. Specifically, the additional processing that is necessary to make roll goods had scratches from the further processing conditions (contact with feed rolls and planar surfaces) making the polypropylene unacceptable. Other unacceptable characteristics of the polypropylene film are described later in the specification.

It is known in the prior art, as stated previously, to employ a continuous roll of plastic to make binder cases. Accordingly, equipment has been produced that takes such a roll of material, aligns it, notches it for corner cutting, glues it, applies a substrate board to the web, folds edges, tucks the corners, cuts the web, and applies a liner, by centering and gluing it to the exposed substrate board and folded edges.

The present invention overcomes the problems encountered when a large production run is not desired, and the problems encountered when the web was scratched when employing polypropylene film.

Another object of this invention is to provide a web process and an apparatus for making binder cases using the web that is economically attractive to fabricate while offering elegant form, fit and finish. It is a further object of this invention to provide a manufacturing apparatus and method of manufacturing wherein said economics may be achieved with small production runs.

### SUMMARY OF THE INVENTION

The present invention overcomes the many problems encountered with the prior art devices and the prior art webs and introduces a much more flexible system for making binder cases using a continuous web.

In all embodiments, the external web material consists of a substantially clear polymer/copolymer film. Additionally, in all embodiments the web incorporates a plurality of replications of images that are required for the external appearance of the end product. Said images are printed under and/or on the inside of said external film. In addition to the external appearance images, the web incorporates alignment marks. Said marks bear a fixed positional relationship to the image associated with each binder case. As the web is processed, sensors detect said marks enabling the processing equipment to accurately actuate such functions as notching and folding.

In one embodiment, the external polymer/copolymer film is reverse-printed with a sufficiently dense image, that said film itself is the web that is processed. This embodiment applies only in cases where the before mentioned plurality of replications of images is a set of optically dense images such that the underlying substrate board is not visible through the print. This is image dependent. This embodiment applies only when the desired image meets density requirements.

In all other embodiments, the external polymer/copolymer is laminated with a flexible, printable interior web material. In some cases, said interior web material is not printed and forms a background to the reverse-printed exterior film. In some cases, the interior web material contains all the printing of said images and said alignment marks. In some cases, the interior web material is printed and the exterior web is reverse printed such that the images and alignment marks are only fully realized when the web is laminated. Said interior web material may be a variety of materials since it is not subject to direct handling in the finished product. For example, the interior web may consist of cut sheets of paper such that the interior web is not continuous and the exterior web is continuous. The interior web may likewise consist of a continuous paper web. The interior web may also be a polymer/copolymer film or cloth.

In the embodiment where cut sheets of paper are used, there is a method for making the continuous web, comprising: printing one or more patterns on multiple sheets of paper, printing at least one alignment mark for each pattern, aligning the multiple sheets of paper end edge to end edge, overlaying said multiple sheets of paper with a continuous film of polymer/copolymer, securing said film to said multiple sheets of paper, and rolling said laminate into a roll whereby said web is continuous with respect to the film but discontinuous with respect to the paper.

For all embodiments, the present invention also comprises a process for making binder cases, comprising: unrolling a web having a continuous external polymer/copolymer film and images having one or more alignment marks thereon, aligning the web to the substrate, bonding the substrate to the web based on the sensed position of said alignment marks, folding the film and bonding the edge on two parallel edges of the substrate, shearing the web between pairs of substrates, folding the film and bonding it to the substrate on the two remaining parallel edges, bonding a liner material over the inside of the binder case and finally adding a preassembled ring mechanism.

With the present invention, smaller production runs are possible and yet the economic benefit of employing roll goods can still be achieved. All embodiments of the present invention solve this problem by printing the material in sheet form and then creating a web that is spooled onto a roll. Rolls allow for faster production, require less handling than sheet feed applications, and need little or no trimming. This technique is much simpler, cheaper, and better quality than using a roll drum for printing purposes.

### BRIEF DESCRIPTION OF THE DRAWINGS

The foregoing and other objects will become more readily apparent by referring to the following detailed description and the appended drawings in which:

FIGS. 1 and 2 are a schematic layout of a machine for making a binder case according to the present invention employing a web. The layout of the machine is so large that two Figures were necessary.

FIG. 3 is a perspective review of the liner process of the present invention.

FIG. 4 is a perspective view of a web, ready for processing according to the present invention.

FIG. 5 is a perspective view lamination process of an embodiment.

FIG. 6 is a flow chart of the materials and printing options according to the present invention.

### DETAILED DESCRIPTION

The film for the web is from 1-mil to 5-mils thick. It may be thicker but generally no further benefit is gained from doing so. In an embodiment, the film provides a protective layer over the printed matter on the sheet and is durable such that scratches are not easily visible. The film must also have sufficient strength to hold the roll together. Polymer/copolymer film that has been stretched in at least one direction to provide good physical properties has suitable strength and durability. Said film may be 100% polyester, however that is not required so long as it has sufficient physical properties to hold the sheets of paper together to form a roll and does not scratch easily. Other films like polypropylene did not have sufficient strength and often broke especially at the border between each sheet. Polypropylene film is less scratch-resistant than polyester and therefore less acceptable. One skilled in the art would therefore seek films that had strengths higher than polypropylene film and similar to that of polyester film. It is not necessary that the film be a homopolymer, it may be a copolymer or a laminate.

Examples of suitable polyesters include: polyethylene terephthalate, polybutylene terephthalate, polypropylene terephthalate, or a mixture of these, or a copolymer of polyester and another polyester, or a copolymer of polyester and polyolefin, like polyethylene or polypropylene (so long as the majority of the polymer is polyester), or a laminate of polyester and polyolefin, wherein the major thickness of the laminate is from polyester so long as the polymer is transparent such that the printed material or pattern can be seen through the continuous polyester film.

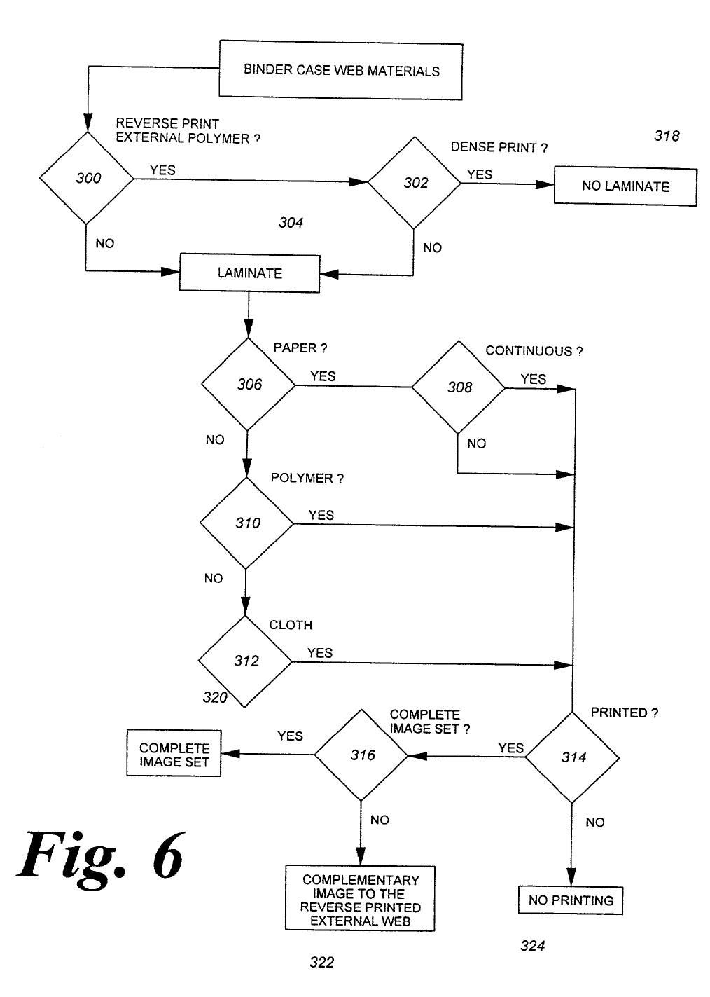

FIG. 6 diagrammatically shows a decision tree of the alternative binder case web materials 298. The external web material consists of a substantially clear polymer/copolymer film. Depending on the details of the desired end product, it may be advantageous to reverse-print an image directly on said film 300. If the print is sufficiently dense (so that it is not transparent) such that the underlying materials are not visible 302, then the web consists simply of that reverse-printed film 318. Outcome 318 has optical alignment marks incorporated in the images as control means during web processing. In all cases, the images may consist of a plurality of replications of images. A single replication corresponds to a single binder case. A plurality of replications may be required in a case where a binder case run produces binder cases that are identical except for image. For example, a replication of English-language images, a replication of Spanish-language images and so forth may form a plurality of replications. If outcome 318 does not apply, the web consists of a laminate 304 because either the reverse printing is not sufficiently dense 302, or if the external film is not printed 300. The interior material that is laminated to form the web may be paper 306. The paper may consist of a continuous web 308 or the paper may consist of discrete sheets each containing images for at least one binder case so that the polymer/copolymer film is continuous and may be processed as a continuous web, but the paper-side is discontinuous. If the interior web is not paper 306, it may consist of a second polymer/copolymer film 310. If the interior material is neither paper or a polymer/copolymer, it may be an alternative web-processable material, for example, cloth 312.

Any of these interior web materials may be printed 314 or simply form a single color background 324 to the reverse-printed external web material 300. Note, that if the external film is not printed, usually the interior web material is printed and must at least have alignment means incorporated. Usually, said alignment means consist of printed bars near the edge of the web that are optically detected during web processing. If the internal web material is printed, it may be printed with a plurality of replications of images, each individual replication being associated with a single binder case as recited in the multiple language example above. The images printed on the internal web material may be complete 320 when the external web is not printed and consists of a substantially transparent film 300, or the internal web material may be printed with images that complement the reverse-printed images on the external polymer/copolymer 322.

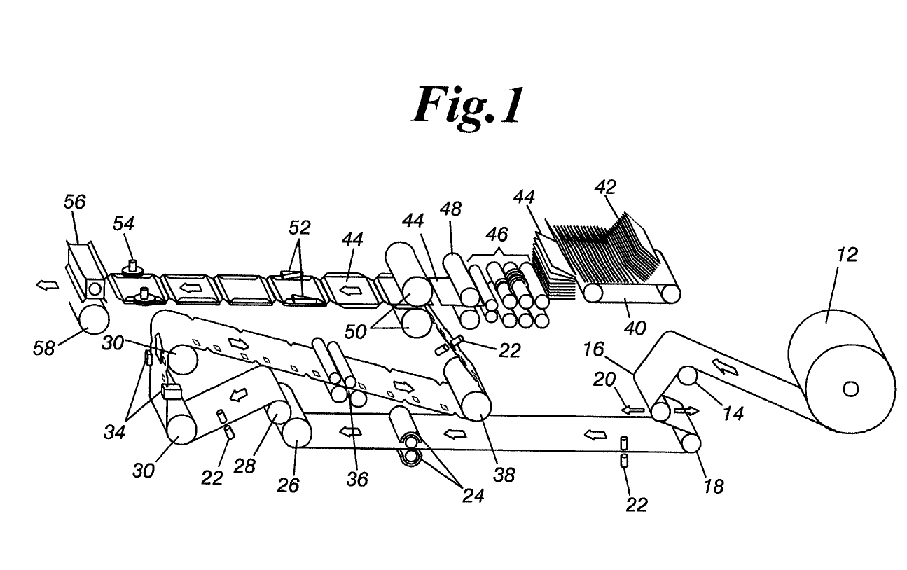

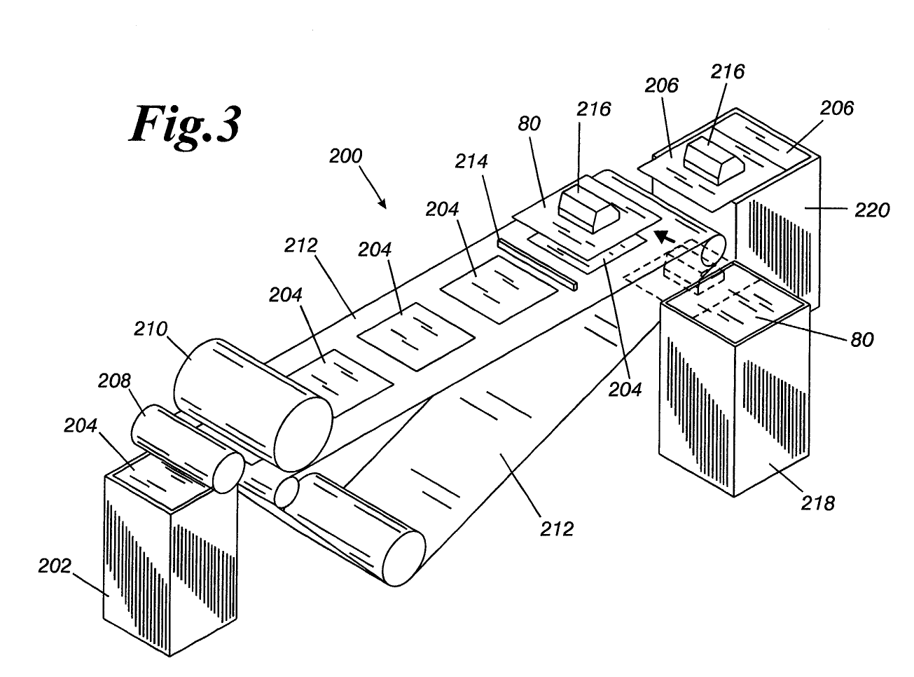

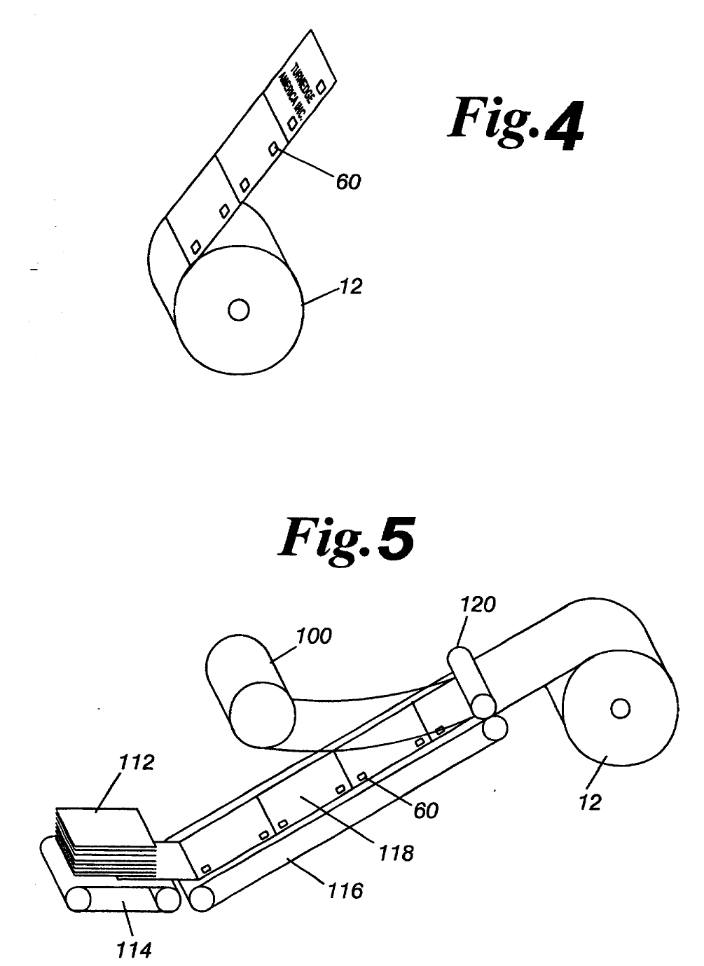

FIGS. 1, 2 and 3 show a typical arrangement of equipment and apparatus to accomplish the process of making a case made binder of the present invention. The assembly shown in FIGS. 1 and 2 is sufficiently long that it could not fit on one page and consequently FIGS. 1 and 2 are necessary to show the entire line. Beginning with FIG. 1, a web 12 is generally supported on a rotational shaft (not shown) such that it may freely unwind. It is unwound over a series of rolls 14, 16 and 18. Roll 16 is mounted so that it can transversely move toward and away from roll 18 as indicated by arrows 20 thereby maintaining a tension on the web so that it remains aligned with downstream apparatus. To index the web for precise process operations which are occurring downstream, a series of indexing means 22 such as photosensors, for example, are schematically illustrated by reference numeral 22. These indexing means are capable of reading the alignment mark 60 shown in FIGS. 4 and 5. The alignment mark 60 is merely a printed symbol that the indexing means 22 is capable of reading, thereby maintaining the position of the web with respect to the processing equipment positioned downstream. One or more of these indexing means may be employed as desired. Generally, indexing means are located immediately before equipment that performs a precise function on the web. The indexing means 22 assures that the web is located precisely where it is needed to execute the function.

The web, moving in the directions indicated by the unnumbered arrows located on the web shown in FIG. 1, next encounters the film surface treatment station 24. Because polymer/copolymer is a fairly inert material and is generally not soluble in water, the vast majority of petroleum products, and most acids, it does not stick to other surfaces including to itself in a suitable manner. Consequently, a surface treatment activates the surface of the polymer/copolymer film on the web 12, such that the polymer/copolymer is more receptive to inks, dyes, paints, adhesives, etc., as is well known in the art. Suitable known surface treatments such as corona, other high-energy radiation treatments like plasma, or open flame will activate the surface of the polymer/copolymer. Corona treatment is preferred. Said surface activation is necessary because the corner finish requires that the subsequently applied adhesive adhere to the polymer/copolymer surface and so that the liner adheres well in subsequent steps. Treatment of both surfaces is illustrated and preferred in embodiments where both surfaces consist of a polymer/copolymer films. In embodiments where a laminate web is used and the interior material is paper or cloth, only the exterior polymer/copolymer film is surface activated. Activation renders the surface chemically receptive to subsequently applied adhesives. In the comers, the material must adhere to itself even when the interior of the web is paper. In addition, the liner must adhere to the exterior of the web to make the interior of the binder case. With activation, the adhesive becomes chemically incorporated in the surface, enabling strong and permanent bonding. The treatment has a half-life of several days, so liner placement must be scheduled soon within that time frame.

Following the surface treatment station, the web traverses through rollers 26, 28 and 30 which, in cooperation with rolls 14, 16, and 18 maintain the web 12 in a taunt position such that is can be uniformly treated by the surface treatment 24 and keep the web 12 in alignment with other apparatus further downstream. Additionally, another indexing means 22 may be positioned, as shown between rolls 28 and 30, to assure that the web is in its proper location.

Again the web 12 is kept taut between rolls 30 and 32 such that a notching device 34, positioned on each side of the web cuts a generally V-shaped notch between each repeated printed matter or pattern as is known in the art of binder making. The notches in the web are desirable so that as the sides of the web are folded over, the notches, in each corner of the binder, prevent or ameliorate bunching of the web in the comers. This aids in giving case made binders an elegant appearance.

The web then proceeds to gluing post 36 where the appropriate side of web 12 is coated with an adhesive, such as a hot melt adhesive. In the first and second embodiments, the appropriate side of the web is the paper side. In the third embodiment where the image is reverse-printed directly on the polymer/copolymer film, the appropriate side is the printed side. Because the web 12 is kept taut between rolls 32 and 38, the adhesive is uniformly applied. The adhesive may be applied by a roller (essentially transferring a uniform layer) or other means such as spraying, as is well known in the art. In the embodiment where the interior web is a polymer/copolymer, the adhesive becomes chemically incorporated in the polymer/copolymer surface because of corona activation. Adhesion with other materials is not a problem because of surface porosity. One or more of rolls, 14, 18, 26 and 38 may be driven by an electric motor, for example, thereby pulling the web 12 from a roll and feeding it to various parts of the line. The number of driven rolls is well within the skill of the equipment producer.

A plurality of substrate boards 42, which are relatively rigid material such as cardboard, fiberboard, corrugated paper, or chipboard, typically 80 or 90 point (1 point=0.001-inches) chipboard, are stacked as shown by reference numeral 42 on a conveyor belt 40 from a hopper or other source of such boards (not shown). These boards are fed individually through a series of rolls 46 until said boards reach the master feed rolls 50. Rolls 46 and 48 are operated at speeds and are indexed to the web speed, such that they feed each board 44 individually onto the web at a precise location. The boards 44 are fed to the inside of the web, which has been coated with the adhesive, by master feed rolls 36. Press rolls 50 press the board securely onto the appropriate side of the web such that the board 44 is positioned centrally between the V-shaped notches (shown, but not referenced).

Next, the side edges of the web 12 are folded over by the folding apparatus 52 positioned on each side of the web. This simple apparatus, in the shape of a curvilinear plow, merely turns the edges of the web, extending beyond the edges of the substrate board, upward and then around the edges of the board, and folded downward on the backside of the board, as is shown. Since these edges were previously coated with the adhesive, the edges adhere to the substrate board. Said edges also partially contact the polymer/copolymer surface and adhere to one another because of the previous surface activation.

Then the web/substrate board proceeds to the corner tuck 54 which folds the sides over in a tight taut fashion so the corners of the binder case, will be nice and neat without any material bunched together at the corners. This apparatus is well known to those skilled in the art of case made binders.

As shown in FIG. 2, the web/substrate board proceeds to cutter 56 positioned over roll 58. The cutter cuts each printed matter or pattern into individual “future binders” by cutting across the width of the web. Each individual web/board is then ejected onto conveyor belt 60 and the front edge is folded over onto the board by means of folding rolls 62. The web/board substrate is ejected onto conveyor belt 64, which likewise positions the web/board substrate onto conveyor belt 66, driven in the direction opposed to the direction of rotation of the conveyor belt 64, such that the tailing edge of the web/board substrate on conveyor belt 64 becomes the leading edge on conveyor belt 66. Conveyor 66 then feeds the web substrate to folding rolls 62, which fold the leading edge over the board the same as was done previously at folding rolls. Because the edges were previously coated with the adhesive, they readily adhere to the substrate board. Then the web/board is deposited on conveyor belt 68 with the board side up and the web side facing the conveyor belt 68. Conveyor 68 transports the web/board to conveyor 72. Conveyor belts 72 and 74 convey the binder case 76 toward an accumulation zone 78. Although conveyor belts 72 and 74 are shown, one conveyor belt may be employed. The accumulation zone 78 feeds each individual binder case into a vertical stack 80 and then a magazine 218.

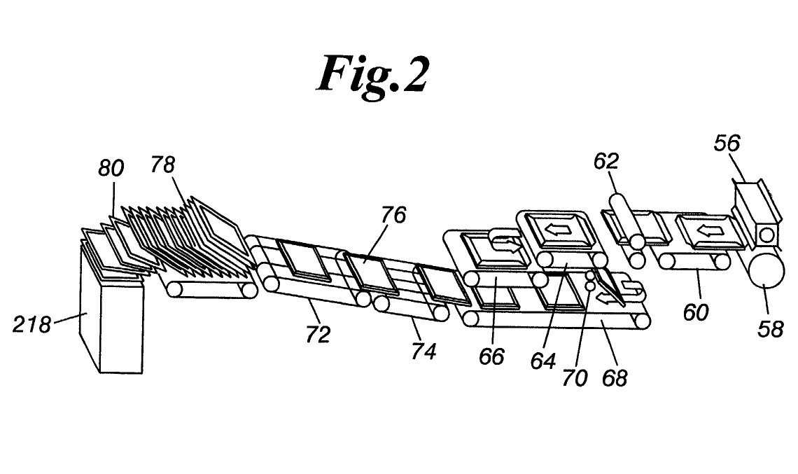

Referring to FIG. 3, binder cases that exit the machine described in FIGS. 1 and 2 have the required exterior appearance under a tough polymer/copolymer film. The edges are smooth and conform to the substrate material. If dadoing is used on either side of the spline, that operation has been performed in a machine that is not shown. On the interior of the binder case, the substrate material is still uncovered. The edge fold of the exterior web shows all around the edge of the substrate at least ¼-inch. Liners, which are delivered to this operation cut to size, are glued in place to hide the substrate and give a finished internal appearance. Said liners are large enough to cover the substrate and a portion of the edge fold. The liner may be a solid color or patterned as required.

Referring again to FIG. 3, a magazine 202 of appropriately sized liners 204, which may be paper, plastic, cloth, or foil laminate, is positioned for material extraction by extractor 208. The extractor is primarily a driven roller of appropriate dimension, however the roller is typically augmented by a pneumatic sheet separator, not shown. The liner material then is coated with an adhesive by the roller coater apparatus 210 in a uniform manner since the liner is captured between the roller and conveyor belt 212. Conveyor belt 212 may be perforated over a negative air pressure plenum to hold each liner firmly in position as it is conveyed. Binder cases lacking liners are contained in magazine 218, face up. Said magazine may contain a spring mechanism to present each incomplete binder case 80 at approximately the same level ready for marriage with a liner. The oncoming liner is sensed by photosensor 214 so that the liner position is precisely known ahead of the marriage step. Pick and place mechanism 216 extracts a binder case lacking a liner from magazine 218 and positions said binder case a short distance above conveyor belt 212. At the appropriate time, pick and place mechanism 216 brings the binder case lacking a liner in firm contact with the adhesive coated liner 204. The pick and place mechanism 216 may then convey the partially complete binder case 206 to magazine 220 for movement to a machine, (not shown) for further processing in which 2, 3 or multiple metal ring retainer clamps commonly found in binders are riveted to the spine of said partially complete binder case 206.

FIG. 5 shows an embodiment in which the web 12 is made by stacking a series of individually printed sheets in a hopper 112 positioned over conveyor belt 114. The printed sheets have a pattern thereon which may be a design, decoration or printed matter, or a combination of two or more of these. Additionally, the printed sheets have one or more alignment marks 60. The exact number of alignment marks employed is well within the skill of the artisan. Conveyor belt 114 directs the individual sheets onto conveyor belt 116 such that the printed sheets are laid end-edge to end-edge. As can be seen, the alignment mark 60 faces upward on conveyor belt 116. The individual sheets laid end-edge to end-edge are covered with the polymer/copolymer film from roll 100. The polymer/copolymer film may be surface treated on the side contacting the sheets and it may be coated with an adhesive (alternatively, the paper sheets may be coated with the adhesive), so long as the pattern is readily and easily visible through the film. Rolls 120 press the film to the sheets. Once the polymer/copolymer film firmly adheres to the printed-paper sheets it is rolled into roll 12, as shown both in FIGS. 1 and 4.

In a second embodiment, the paper web 118 consists of a continuous paper web with multiple images printed thereon. The printed images also contain alignment marks for triggering web processing actions as previously described. Although generally minor, the first embodiment may evoke variation in web processing flow to account for minor lack of precision of placement from one paper sheet to the next. This variation is eliminated in the second embodiment which may be an advantage, depending on job size and image details.

In a third embodiment, paper is eliminated completely. If the image is sufficiently dense, that said image is macroscopically opaque when printed on a transparent material, the polymer/copolymer may be surface conditioned and the desired image reverse-printed directly on the polymer/copolymer film. This eliminates the polymer/copolymer web to paper web bonding process and substantially reduces the materials cost in producing a binder case. This option is image dependent and cannot always be used. The image may be a simple repetition of a single image or may be a plurality of repetitions of various images. For example, a web might contain a number of English-language annotated images and a different number of Spanish-language annotated images for a binders intended for speakers of those languages.

A fourth embodiment is also image dependent. Full color printing is usually effected by printing with four colored inks: cyan, magenta, yellow and black. Combinations of these inks in varying densities can produce colors in a triangular gamut on a CIE chart and are sufficient to produce general images including photographic images. Color inks and color ink printing technologies are generally substantially more expensive than black ink on white printing. Each image may be analyzed, when appropriate, a foreground image may be reversed-printed on the external polymer/copolymer web and a background image printed on a paper or possibly a cloth web or second polymer/copolymer web. An example of an image employing this embodiment is a substantially black and white image with a easily separable color photograph. Rather than use the relatively expensive color inking system for the entire image, the background black and white image may be printed on paper and the color photo reverse-printed on the polymer/copolymer web. The paper and film webs are then bonded as shown in FIG. 5.

In cases where the desired image is sparse, the background will be white with no printing at all. In some cases the foreground and background designations become equivocal. It is sometimes advantageous to print a plurality of repetitions, for example, a repetition for each language on either the foreground or background while the mating background or foreground is a continuous repetition. It should be noted that a somewhat broader class of materials may be used for the internal web (paper of various weights, cloth and a larger variety of polymeric materials).

In operation, although FIGS. 1, 2 and 3 show a layout of apparatus designed to make binder cases by employing the web of the present invention, it is not necessary that the exact steps recited and shown in the drawings are employed, so long as there are some means for unrolling the web 12, indexing it, such as by means of photosensors 22, applying an adhesive as is done by apparatus 36, applying the board substrate to the adhesive as is done by pressure rolls 50, folding the side edges as illustrated by folders 52, cutting the web into individual sections such as shown by apparatus 56, folding the remaining edges of the web onto the board as is shown by folding rolls 62 and 70, and optionally, applying a liner as is shown in FIG. 3.

Those skilled in the art will recognize that within these boundaries many different variations can be made without impairing the spirit of the invention.

What is claimed is:

1. A web, for forming the exterior surface of a binder case, comprising a polymer/copolymer film, said film having a plurality of replications of images reverse-printed thereon, and said images include at least one alignment mark per image.

2. The web of claim 2, wherein said reverse-printed images are sufficiently optically dense to stand alone as the exterior appearance of said binder case.

3. The web of claim 2, wherein a flexible, printable, interior web material is bonded to said film to form a laminate web

4. The web of claim 3, wherein said interior web material is selected from the group of:
a continuous paper web, cloth and a polymer/copolymer film.

5. The web of claim 3, wherein said interior web material consists of paper sheets such that the film side of the laminate is continuous and the paper side of the laminate is discontinuous.

6. The web of claim 3, wherein a plurality of replications of images are printed on said interior web.

7. The web of claim 1, wherein said alignment mark is positioned at the side edge of said web.

8. A web roll comprising: a laminate of numerous sheets of paper having a printed pattern thereon, each of said numerous sheets of paper laid end-edge to end-edge, and a continuous film of polyester secured to said numerous sheets of paper such that said web is continuous with respect to said film of polyester, but discontinuous with respect to said numerous sheets of paper.

9. The web roll laminate of claim 9, wherein said printed pattern includes at least one alignment spot per pattern.

10. The web roll laminate of claim 10, wherein said alignment spot is positioned at the side edge of said web roll laminate.

11. The web roll laminate of claim 9, wherein said printed pattern is repeated on each sheet.

12. The web roll laminate of claim 9, wherein said printed pattern is different for each sheet.

13. A method of making a continuous web, comprising:
printing one or more images on multiple sheets of paper,
aligning said multiple sheets of paper end-edge to end-edge,
overlaying said multiple sheets of paper with a continuous film of polymer/copolymer,
securing said film to said multiple sheets of paper, and
rolling said laminate into a roll whereby said web is continuous with respect to said film, but discontinuous with respect to said paper.

14. The method of claim 14, including the additional step of printing at least one alignment spot for each of said sheets.

15. The method of claim 15, wherein said alignment spot is at a side edge of said sheets.

16. A method of making a continuous web, comprising:
printing a plurality of replication of images on a web of flexible, printable web material;
reverse-printing a second plurality of patterns on a polymer/copolymer web, and
securing a continuous film of polymer/copolymer to said flexible, printable web material.

17. A process for making binder cases, comprising:
unrolling a web having a continuous polymer/copolymer film side having a plurality of alignment marks;
aligning said web by employing said alignment mark;
notching each side of said web;
applying adhesive to said internal side of said web;
positioning a substrate board smaller than said web width on said internal side of said web;
pressing said substrate board to said internal side of said web;
folding the side edges of said web onto said board;
cutting said web between said patterns;
folding the leading and trailing edges of said web onto said board;
applying adhesive to a liner;
centering said liner over said board substrate and over said folded edges of said web; and
applying pressure to said liner and said web/board substrate to form a case made binder.
